(19) United States
(12) Patent Application Publication
(10) Pub. No.: US 2025/0012691 A1
(43) Pub. Date: Jan. 9, 2025

(54) METHOD OF SAMPLING AND ANALYZING PROPERTIES OF DISCHARGED FILTER CAKE AND APPARATUS THEREOF

(71) Applicant: FLSmidth A/S, Valby (DK)

(72) Inventors: Thien Sok, Sandy, UT (US); Michael Hidding, Cardup (AU); Trevor Bruce, Sandton (ZA); James Chaponnel, Cottonwood Heights, UT (US)

(21) Appl. No.: 18/707,157

(22) PCT Filed: Nov. 1, 2022
(86) PCT No.: PCT/IB2022/060514

§ 371 Date: May 2, 2024

Related U.S. Application Data
(60) Provisional application No. 63/274,584, filed on Nov. 2, 2021.

(51) Int. Cl. G01N 5/04

(52) U.S. Cl. CPC G01N 5/045

(57) ABSTRACT

A filter cake analyser (1) is disclosed. The analyser (1) may include a probe (7) configured to extend into a path of filter cake (6) (or other material) and convey a sample amount of filter cake (6) from a catch basin (9) to a probe discharge (11). A sample cup (17) of an indexable cup assembly (16) is filled with the sample amount of filter cake (6). A rotational actuator (22) supporting the cup assembly (16) indexes the cup assembly (16) between three cup assembly positions. A dryer (15) of the filter cake analyser (1) dries the contents of the sample cup (17), and a load cell (28) intermittently engages and disengages with the cup assembly (16) via an actuator (26) to obtain dry and wet mass measurement values to calculate moisture content of the sample amount of filter cake (6).

### FIELD OF THE INVENTION

Embodiments of the present invention pertain to improvements to industrial filters, for example, horizontal filter presses, belt presses, pneumatic chamber filters, drum filters, disk filters, pressure filters, vacuum filters, and the like. In particular, embodiments of the present invention relate to a unique filter cake analyser module comprising means for determining filter cake moisture content, particle size distribution, and/or mineralogy.

### BACKGROUND OF THE INVENTION

Reference to background art herein is not to be construed as an admission that such art constitutes common general knowledge in the arts.

In many industrial dewatering processes, filters are used to dewater a slurry and produce a filter cake. Filter cake is discharged from a filter and normally enters a catch basin (e.g., train car) or falls onto a conveyor for transport to a tailings storage facility (TSF). It is desirable to know the moisture content of the discharged cake to determine filter performance.

Operational settings used to operate a filter can affect filter cake density, moisture, and/or other qualities of the filter cake produced by the filter. Moisture content (%) of the filter-produced cake is generally considered to be the most critical quality measurement for determining the efficiency and performance of industrial filters.

It is important, especially when disposing filter cake as geo-stable tailings, that the filter cake produced meets or stays below a predetermined moisture content threshold to ensure that the tailings disposal site remains geo-stable. If the cake moisture (%) of the produced filter cake remains within spec, or filter cake moisture content consistently stays below a predetermined threshold, it may be possible to adjust or optimize filter operational input settings for better efficiency, economic improvements (e.g., reduced OPEX), and energy use reduction.

In addition to allowing optimization of the filter, real-time cake moisture feedback information may also allow optimization of the dewatering operation as a whole. Cake moisture feedback can also mitigate penalties associated with the production of off-spec cake exceeding moisture content thresholds.

Conventional methods (e.g., those incorporating microwave-based, infrared imaging-based, and conductivity-based sensors) for performing online moisture analysis of filter cake tend to fail due to calibration changes with changing ore composition within the slurry feed to the filter.

Embodiments of the present invention aim to improve upon existing conventional manual ‘batch’ techniques currently used to determine cake moisture. Such methods are performed infrequently and may introduce human error.

Embodiments also aim to improve upon conventional online analysis methods which result in less-accurate readings due to the aforementioned calibration challenges.

### OBJECTS OF THE INVENTION

It is an aim that embodiments of the invention provide an improved apparatus and method for analysing discharged filter cake which overcomes or ameliorates one or more of the disadvantages or problems described above, or which at least provides a useful alternative to related conventional apparatus.

In particular, it is an aim that embodiments of the present invention help provide improved means for allowing precise moisture measurement of discharged filter cake without the need for constant calibration due to mineral changes in filter infeed slurry (e.g., in cases of filtered mining tailings or other filtered material).

It should be understood that not every embodiment may be configured to obtain each and every one of the abovementioned objects. However, specific embodiments may demonstrate the ability to achieve or satisfy at least one or more of the abovementioned goals.

Other preferred objects of the present invention will become apparent from the following description.

### SUMMARY OF INVENTION

Embodiments of the invention employ gravity-based measurement techniques by means of physically pulling a sample amount of filter cake being discharged from a filter, weighing the collected sample of filter cake, drying the collected sample of filter cake, and weighing the dried filter cake sample to calculate moisture content of the sample amount of filter cake.

Doing this can advantageously avoid the need for frequent cumbersome calibrations that are necessary with other conventional online filter cake sensors.

The proffered embodiments employ a batch process with short period and high frequency (e.g., on the order of minutes), and are intended to provide frequent valuable data (given the current alternatives which provide very little data, infrequently). In some cases (e.g., filter presses, disc filters), filter cake moisture analysis measurements may be taken at each batch filtration cycle. In other cases, (e.g., drum filters), filter cake moisture analysis measurements may be taken periodically from a continuous filter cake discharge stream.

A filter cake analyser (1) is disclosed. The filter cake analyser (1) may be configured to collect a sample of filter cake (6) produced by a filter. The analyser (1) may comprise a probe (7). The probe (7) may be configured to extend into a path of the filter cake (6). The probe (7) may comprise a catch basin (9). The catch basin (9) may be configured for collecting a sample amount of the filter cake (6) therein. The probe (7) may comprise a probe discharge (11). The probe may comprise means (10, 10′, 10″) for transporting collected filter cake (6) from the catch basin (9) to the probe discharge (11).

The filter cake analyser (1) may comprise a cup assembly (16). The cup assembly (16) may be indexable between three cup assembly positions. The cup assembly (16) may comprise a sample cup (17) provided to an upper proximal portion of the cup assembly (16), a shaft (18), and means (21) provided to the cup assembly (16) for limiting downward travel of the cup assembly (16) (e.g., within a bearing (24)).

The filter cake analyser (1) may comprise a rotational actuator (22) supporting the cup assembly (16) (e.g., via the bearing (24)), and which may be configured to index the cup assembly (16) into the three cup assembly positions.

The filter cake analyser (1) may comprise a dryer (15) for drying contents of the sample cup (17). The filter cake analyser (1) may comprise a load cell (28). A portion (29) of the load cell (28) may be configured to engage a portion (20) of the cup assembly (16) and/or disengage the cup assembly (16). This may be accomplished, for example, via the provision and use of an actuator (26), without limitation.

In a first cup assembly position of said three cup assembly positions, the sample cup (17) may be arranged above the load cell (28) and beneath the probe discharge (11), for example to catch collected filter cake (6) passing therethrough.

In a second cup assembly position of said three cup assembly positions, the sample cup (17) may be arranged adjacent the dryer (15), without limitation.

In a third cup assembly position of said three cup assembly positions, contents of the sample cup (17) may be removed therefrom, for example, moved to a sample discharge chute/hopper (32), without limitation.

In some embodiments of the filter cake analyser (1), the dryer (15) may comprise an infrared (IR) lamp.

In some embodiments, the filter cake analyser (1) may comprise a sprayer (33) for cleaning out inside surfaces of the sample cup (17) in the third cup assembly position. The sprayer (33) may be configured to introduce a fluid such as a gas and/or a liquid into the sample cup (17), without limitation.

In some embodiments, the filter cake analyser (1) may comprise a spinner (31) for rotating the cup assembly (16) (e.g., within the bearing (24)) in the second cup assembly position.

In some embodiments, the means (10, 10′, 10″) for transporting collected filter cake (6) from the catch basin (9) to the probe discharge (11) may comprise a transport screw or auger, a plunger, or a rotatable cup, without limitation.

In some embodiments, the means (10, 10′, 10″) for transporting collected filter cake (6) from the catch basin (9) to the probe discharge (11) comprises a drive (12) in the form of a motor or a cylinder, without limitation.

In some embodiments, the filter cake analyser (1) may comprise means (56) for measuring particle size of particulates within the collected filter cake (6), without limitation.

In some embodiments, the filter cake analyser (1) may comprise means (50) for determining the mineralogy and/or composition of particulates within the collected filter cake (6), without limitation.

A filter may comprise a filter cake analyser (1) as described above. For example, a cake discharge chute (5) portion of a filter may comprise a filter cake analyser (1) as described above.

A method of analyzing a sample of collected filter cake (6) discharged from a filter using the filter cake analyser (1) described above is also disclosed. The method may comprise any one or more of the following steps, in any particular order:
collecting filter cake (6) in the catch basin (9);
transporting a portion of the collected filter cake (6) from the catch basin (9) to the probe discharge (11);
filling the sample cup (17) with a portion of the collected filter cake (6) via the probe discharge;
weighing the cup assembly (16) to obtain a wet mass;
drying the contents of the sample cup (17) with the dryer (15);
weighing the cup assembly (16) to obtain a dry mass;
determining moisture content of the collected filter cake (6) using the wet mass and dry mass;
discharging the contents of the sample cup (17).

The method may comprise the step of cleaning the sample cup (17) using a sprayer (33) as described above.

The method may comprise the step of drying the sample cup (17) after the step of cleaning the sample cup (17).

The method may comprise the step of weighing the cup assembly (16) with the sample cup (17) dry and empty. The method may comprise the step of zeroing the load cell (28) mass to negate the tare weight of the cup assembly (16) (including any residual sample material therein) and ready the filter cake analyser (1) for additional measurements.

In some embodiments, an analyser (1) is provided. The analyser (1) may be configured to collect and/or measure a sample of solids (6) leaving a conveyor belt (2) and/or passing through a chute or hopper (5). The analyser (1) may comprise a probe (7). The probe (7) may be configured to extend into a path of the solids (6). The probe (7) may comprise a catch basin (9). The catch basin (9) may be configured for collecting a sample amount of the solids (6) therein. The probe (7) may comprise a probe discharge (11). The probe (7) may comprise means (10, 10′, 10″) for transporting collected solids (6) from the catch basin (9) to the probe discharge (11), without limitation.

The analyser (1) may comprise a cup assembly (16). The cup assembly (16) may be indexable between three cup assembly positions. The cup assembly (16) may comprise a sample cup (17). The sample cup (17) may be provided to an upper proximal portion of the cup assembly (16). The cup assembly (16) may comprise a shaft (18), and may comprise means (21) provided to the cup assembly (16) for limiting downward travel of the cup assembly (16). In some embodiments, the shaft (18) of the cup assembly (16) may articulate within a bearing (24).

The analyser (1) may comprise a rotational actuator (22) supporting the cup assembly (16). The rotational actuator (22) may support the cup assembly (16) via the bearing (24). The rotational actuator (22) may be configured to index the cup assembly (16) into said three cup assembly positions, without limitation.

The analyser (1) may comprise dryer (15), for drying contents of the sample cup (17). The analyser (1) may comprise a load cell (28). The load cell (28) may be configured to engage the cup assembly (16) and/or disengage the cup assembly (16). This engagement and/or disengagement may be facilitated via the provision and use of an actuator (26), without limitation.

In a first cup assembly position of said three cup assembly positions, the sample cup (17) may be arranged above the load cell (28) and/or beneath the probe discharge (11) to catch collected solids (6) passing therethrough, without limitation.

In a second cup assembly position of said three cup assembly positions, the sample cup (17) may be arranged adjacent the dryer (15), without limitation.

In a third cup assembly position of said three cup assembly positions, contents of the sample cup (17) may be removed therefrom, without limitation.

In some embodiments, the solids (6) collected and/or measured may comprise filter cake (6) produced by a filter, a dewatered concentrate, mineral sands, phosphate, and/or a material having high solids concentration, without limitation.

The analyser (1) may be positioned with its probe (7) within a discharge chute (5), without limitation. The analyser (1) may be positioned with its probe (7) extending above a conveyor belt (2) such that it is configured to capture solids (6) being conveyed by the conveyor belt (2). The analyser (1) may be positioned with its probe (7) extending across the discharge chute (5), for example, substantially perpendicularly to the flow of the solids (6), without limitation.

Further features and advantages of the present invention will become apparent from the following detailed description.

### BRIEF DESCRIPTION OF THE DRAWINGS

By way of example only, preferred embodiments of the invention will be described more fully hereinafter with reference to the accompanying figures. It will be appreciated from the drawings that some of the figures may intentionally omit features or hide components for clarity and/or better visualization and understanding of the invention. Moreover, for clarity, where there are a plurality of similar features in a particular figure, only one of the features may be labelled with reference numerals.

FIG. 1 is a schematic side view of a non-limiting embodiment of a filter cake analyser 1 shown positioned in relation to a discharge end 4 of a filter cake conveyor belt 2. The analyser 1 may be positioned adjacent to a cake discharge chute 5.

FIG. 2 is an isometric view showing a different view of the filter cake analyser 1 embodiment depicted in FIG. 1.

FIG. 3 depicts a first method step of collecting a sample of discharged filter cake 6 and conveying it (via a transport screw 10) to a probe discharge 11 configured to direct sample material to fill a sample cup 17 provided to an indexable cup assembly 16.

FIG. 4 depicts a second method step involving engaging an abutment surface 29 of a load cell 28 (e.g., a pneumatic platen) with a distal end 20 of a cup assembly 16 in a first cup assembly position, in order to weigh the sample of filter cake 6 collected within the sample cup 17.

FIG. 5 depicts a third method step of disengaging the abutment surface 29 of load cell 28 from the distal end 20 of a cup assembly 16.

FIG. 6 depicts a fourth method step of rotating the cup assembly 16 from the first cup assembly position to a second cup assembly position (e.g., via a rotational actuator 22), in order to expose the contents of the sample cup 17 to a dryer 15, and optionally rotating the cup assembly 16 using a cup assembly spinner 31 provided to the analyser 1.

FIG. 7 depicts a fifth method step of rotating the cup assembly back into the first cup assembly position via the rotational actuator 22.

FIG. 8 depicts a sixth method step of re-engaging the abutment surface 29 of the load cell 28 with the distal end 20 of the cup assembly 16 in the first cup assembly position, in order to weigh the dried filter cake sample contents remaining in the sample cup 17—e.g., in a manner which is similar to the second method step.

FIG. 9 depicts a seventh method step of disengaging the abutment surface 29 of the load cell 28 from the distal end 20 of the cup assembly 16 in the first cup assembly position in a manner which is similar to the third method step.

FIG. 10 depicts an eighth method step of rotating the cup assembly 16 via the rotational actuator 22, to remove the dried contents of the sample cup 17, e.g., by dumping into a sample discharge chute 32, and optionally blowing gas and/or liquid into the sample cup 17 with a sprayer 33 to remove residual contents therefrom.

FIG. 11 depicts a ninth method step of rotating the cup assembly 16 via the rotational actuator 22, back to the second cup assembly position to dry the emptied sample cup 17 in a manner similar to the fourth method step. The dryer 15 may help remove any additional moisture within the sample cup 17 that may have been introduced by the sprayer 33 during the wash cycle depicted in FIG. 10.

FIG. 12 depicts a tenth method step of rotating the cup assembly 16 back to the first cup assembly position via the rotational actuator 22 in preparation for a calibration and/or zeroing cycle.

FIG. 13 depicts an eleventh method step of re-engaging the abutment surface 29 of the load cell 28 with the distal end 20 of the cup assembly 16 in the first cup assembly position, in order to zero out the empty tare weight of the cup assembly 16—e.g., in a manner similar to the second and sixth method steps.

FIG. 14 depicts a twelfth method step of disengaging the abutment surface 29 of the load cell 28 from the distal end 20 of the cup assembly 16 in the first cup assembly position—e.g., in a manner similar to the third and seventh method steps. In this regard, method step 1 can begin again and a new filter cake sample can be received within the sample cup 17.

FIG. 15 depicts a method of using a filter cake analyser 1 according to some embodiments.

FIG. 16 depicts an optional, supplemental method that may be used in conjunction with the method depicted in FIG. 15. This supplemental method may include the steps of further analysing the filter cake sample discharged from the sample cup 17 during the eighth method step shown in FIG. 10. Namely, optional additional steps may be taken to measure mean particle size/particle size distribution (PSD), and/or mineralogy or composition of a collected filter cake 6 sample. Several process steps such as grinding and pressing the sample for analysis may be employed, without limitation.

FIG. 17 depicts optional, supplemental apparatus which may be employed with embodiments of a filter cake analyser 1 and used to complete the optional supplemental method steps described in FIG. 16.

FIG. 18 depicts an alternative probe 7 configuration which uses a plunger-style sample transport mechanism rather than a transport screw. As depicted, alternative embodiments of a filter cake analyser 1, may employ a linear actuator as the drive 12, rather than a motor drive.

FIG. 19 depicts yet another alternative probe 7 which utilizes a plunger-type mechanism having a cup positioned on a movable rod for use as a sample transport mechanism. Such alternative embodiments of a filter cake analyser 1 probe 7 may employ a linear actuator as the drive 12 to actuate the plunger-type mechanism.

FIGS. 20-27 depict a prototype embodiment of an analyser 1 configured for industrial use as a pilot unit.

### DETAILED DESCRIPTION OF THE DRAWINGS

A filter cake analyser 1 for an industrial filtering machine is disclosed. The filter cake analyser 1 may be positioned adjacent a filter cake discharge point 4, for example, at a location downstream of a filter and/or a filter cake conveyor belt 2 having an end roller 3 supporting a belt.

The filter cake analyser 1 may be, for instance, placed adjacent to or within a shielded portion of a cake discharge chute 5, without limitation. As shown, the filter cake analyser 1 may be positioned outside of the cake discharge chute 5 to be protected from contamination from a falling stream of filter cake 6 leaving the filtering machine.

A probe 7 may protrude into the cake discharge chute 5 as shown, such that a distal end 8 of the probe extends into or past a falling filter cake 6 flow path. It will be appreciated that while not shown, the probe 7 may alternatively be positioned just above the filter cake conveyor belt 2 and extend into a traveling bed of filter cake material leaving the industrial filter and being transported thereon (e.g., to a TSF), without limitation.

In the particular embodiment shown, the probe 7 may be designed to catch falling filter cake 6 in a catch basin 9. As filter cake 6 enters the cake discharge chute 5, a catch basin 9 within an upper portion of the probe 7 fills with a sample amount of filter cake 6. Superfluous filter cake 6 may spill over the probe 7.

Once the catch basin 9 is sufficiently filled with sample cake 6, a transport screw 10 within the probe 7 may be rotationally driven by a drive 12. The drive 12 may be configured to convey or draw the gathered sample of filter cake gathered within the catch basin 9 out of the flow path within chute 5, and through the body of probe 7 to a probe discharge 11. Once the collected sample of filter cake 6 reaches the probe discharge 11, it may be subsequently transferred to a sample cup 17 portion of a cup assembly 16, e.g., by gravity (i.e., falling). In the particular embodiment shown, the drive 12 may comprise a motor with a gear or belt-type transmission/reducer, without limitation. Other means for driving transport screw 10 known in the art may be used (e.g., pneumatic motor, electric motor, etc.).

A chassis 13 of the filter cake analyser 1 may comprise a drive support mount 14 for supporting and connecting the drive 12 thereto. The chassis 13 may also support a dryer 15. The dryer 15 may comprise a heat lamp, electric heater, microwave, fan, and/or other means for drying damp solids, without limitation.

The dryer 15 may use conduction and/or convection heating methods for drying. In preferred embodiments, dryer 15 may be configured to emit light or radiant energy, and may heat the collected sample of filter cake via infrared (IR) electromagnetic radiation, without limitation.

The chassis 13 may also comprise an actuator support mount 25 for supporting an actuator 26 (e.g., a cylinder, solenoid, linear screw drive, movable linkage). The actuator 26 may be provided as a pneumatic platen which raises and lowers a load cell 28. The chassis 13 may also support a rotational actuator 22 comprising a rotating plate 23. The rotating plate 23 may serve to secure a bearing 24 (e.g., linear and/or rotational sleeve bearing) thereto for supporting the cup assembly 16.

The cup assembly 16 may comprise a shaft 18, a sample cup 17 at an upper distal end of the shaft 18, and a lower distal end 20 which is configured to contact an upper abutment surface 29 of the load cell 28. The cup assembly 16 may further comprise a stop limiter 21 which may be provided to the shaft 18 above the bearing 24 and which may be configured to prevent further downward movement of shaft 18 in bearing 24. The cup assembly 16 may, in some embodiments, comprise an optional flange 19 for use in aligning the cup assembly 16 with a cup assembly spinner 31 mechanism and/or for acting as a guide or roller with respect to portions of the cup assembly spinner 31. In some embodiments, this flange 19 may comprise a friction surface which engages a rotating friction surface of the spinner 31.

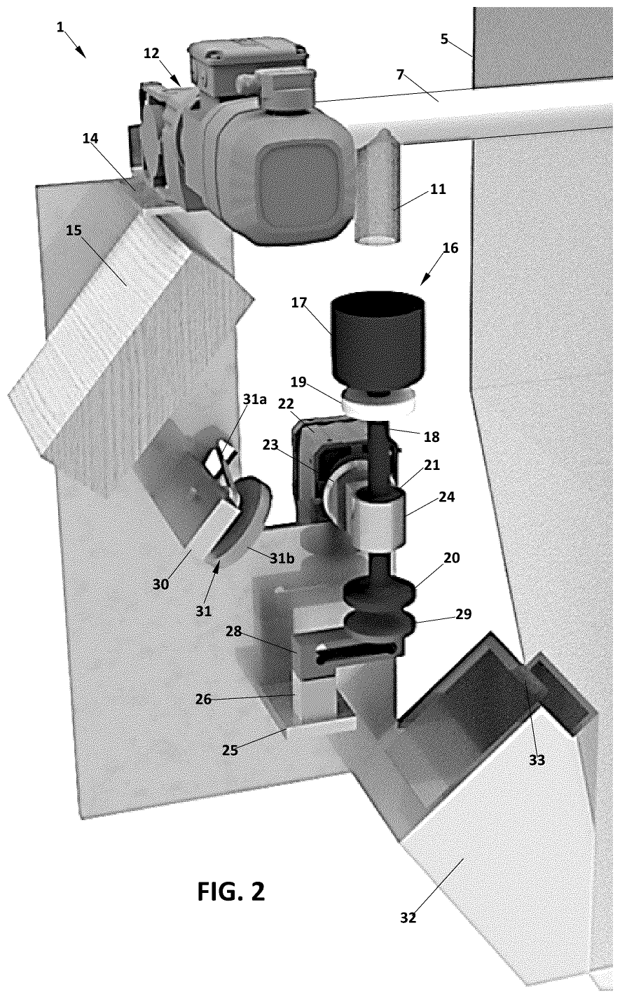

As shown (and most clearly seen from FIG. 2), in some embodiments, spinner 31 may comprise a rotating driven belt 31a. This rotating driven belt 31a of the cup assembly spinner 31 may contact an outer surface of sample cup 17, which, in turn, rotates the cup assembly 16 within bearing 24. An idler wheel 31b portion of the cup assembly spinner 31 may contact a portion of the shaft 18 and/or the flange 19, and serve to support and/or align the cup assembly 16 with spinner 31 during rotation, without limitation. The belt 31a and idler 31b may be supported by a respective support mount 30 on the chassis 13. It should be understood that while not depicted in the accompanying drawings, the spinner 31 may alternatively be provided to the rotating plate 23.

It is further envisaged that rather than contacting an outer surface of sample cup 17, the rotating driven belt 31a of the cup assembly spinner mechanism 31 may instead make contact with the outer peripheral surface of the flange 19, without limitation. It is further envisaged that the rotating driven belt 31a may be replaced with a rotating wheel, gear, or other means for turning cup assembly 16 about its longitudinal shaft 18 axis within bearing 24. It is further envisaged that the rotating driven belt 31a may drive/spin wheel 31b, and the spinning wheel 31b may serve to rotate cup assembly upon frictional engagement therewith.

The actuator 26 supported by the chassis 13 may comprise an actuated rod or shaft 27 as shown. The upper end of the actuated rod or shaft 27 may comprise a load cell 28 provided with an upper abutment surface 29 for making contact with the lower distal end 20 of the cup assembly 16. It is envisaged that the actuator 26 may comprise a driven worm gear and the actuated rod or shaft 27 may comprise a driven linear screw, without limitation. It is envisaged that the actuator 26 may comprise a pneumatically-driven piston rod or shaft, without limitation. It is envisaged that the actuator 26 (e.g., a solenoid) may comprise an electromagnetically-activated rod or shaft 27, without limitation. It is also anticipated that other means for moving the load cell 28 may be used (e.g., an actuated linkage) to kinematically raise and lower the load cell 28 into engagement and disengagement with cup assembly 16 for weighing the cup assembly with or without contents within the sample cup 17.

The rotational actuator 22 may be configured to move the cup assembly 16 between three distinct cup assembly positions. As depicted, these positions may be different angular positions of the cup assembly in relation to the chassis 13. In a third cup assembly position, the sample cup 17 may be tipped so as to be at least partially inverted by the rotational actuator 22 such that the distal end 20 of the cup assembly is temporarily positioned higher than the proximal sample cup 17. In this regard, contents within the sample cup 17 may be discharged therefrom by gravity.

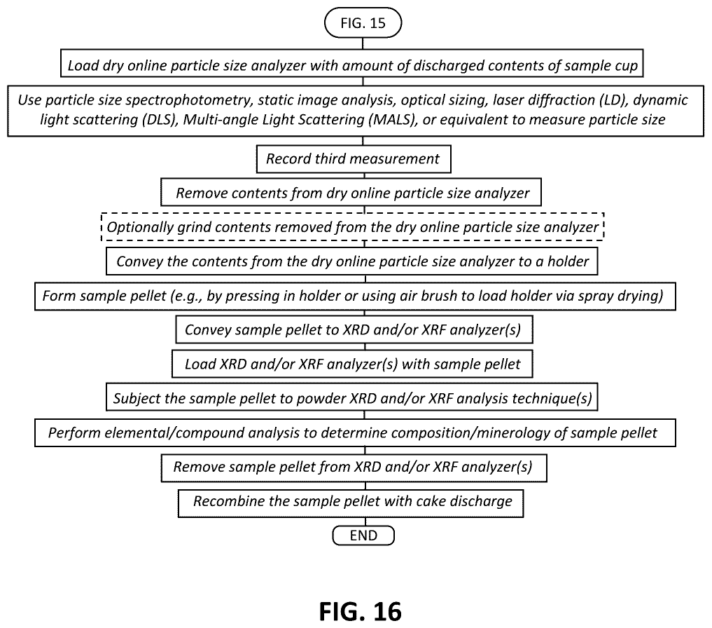

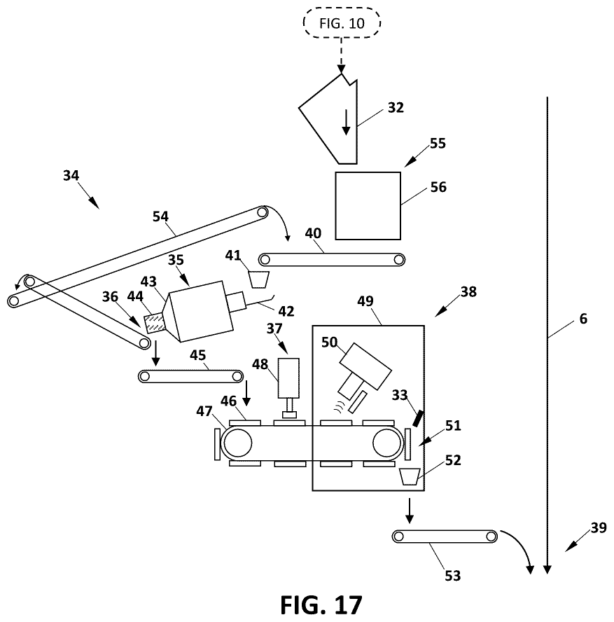

In the third cup assembly position (FIG. 10), contents within the sample cup 17 may be spilled into a sample discharge chute/hopper 32, re-combined with the cake 6 flow path within cake discharge chute 5, or moved to an optional secondary analyzing circuit 34 as will be appreciated from FIGS. 16 and 17, without limitation.

While in the third cup assembly position, inner surfaces of the sample cup 17 may be cleaned with a sprayer 33. The sprayer 33 may be fluidly connected to a gas and/or liquid source and may be adequately positioned, oriented, and configured to spray the gas and/or liquid across inner surfaces of the sample cup 17. While not depicted, a cup assembly spinner 31 similar to that shown in FIG. 2 may be provided adjacent the sample discharge chute 32 or sprayer 33, or, it may be provided on the rotating plate 23 to accomplish this optional functionality of spinning the cup assembly while the sprayer 33 cleans the internal surfaces of sample cup. Alternatively, in some embodiments, sprayer may move along a predetermined track or its orientation may be adjusted to ensure internal surfaces of sample cup are substantially free of residue. Sprayer 33 may be configured to remove residual material in sample cup 17.

Turning now to FIGS. 16 and 17, an optional secondary analyzing circuit 34 may be provided as a component of filter cake analyser 1 to complement moisture content measurement. The secondary analyzing circuit 34 may comprise means for determining particle size (e.g., particle size distribution, mean particle size), and/or mineralogy/composition of the dried sample, without limitation. These optional apparatus and method steps may be employed to gather additional information about the collected cake discharge 6 sample in addition to (%) moisture content.

The secondary analyzing circuit 34 may comprise a particle size analyzing circuit 55 configured to receive the sample discharged at the third cup assembly position (FIG. 10). This material may enter the particle size analyzing circuit prior to fluids leaving sprayer 33.

The material discharged from the particle size analyzing circuit 55 may be discarded, transported to a downstream process, re-combined with cake discharge 6 in chute 5, or subsequently enter miniaturized grinding circuit 35 for grinding as shown. The ground sample leaving the grinding circuit 35 may proceed to a screening circuit 36 where undersize particles are permitted to pass to a sample pressing circuit 37, and oversized particles follow a regrind conveyor 54 to re-enter the grinding circuit 35 for additional particle size reduction. It should be understood that if filter cake 6 discharged from the filter contains fines, a grinding circuit 35 may not be required and material discharged from the particle size analyzing circuit 55 may directly enter the pressing circuit 37.

After pressing the undersized particles in a holder 46, the pressed sample and holder 46 may move to a mineralogy analysis circuit 38 (e.g., XRF and/or XRD analysis stage) to determine the mineralogy and/or composition of the sample. Thereafter, the sample may be discarded or enter a recombination stage 39 where it can be re-joined with the flow of filter cake discharge 6.

Material leaving the sample cup 17 in the third cup assembly position (FIG. 10) may be removed (e.g., via gravity) and enter sample discharge chute 32, or it may be spilled directly into an infeed receiving portion of a particle size analyser 56. The particle size analyzer may be of any type known in the art (e.g., a product offered by Malvern Panalytical). The particle size analyser 56 may be equipped with means for executing laser diffraction-, image/optical analysis-, dynamic light scattering-, and/or spatial filter velocimetry-based measurements, without limitation. For example, a Malvern Insitec® Dry online particle size analyzer may be used.

The particle size analyser 56 may determine particle size information pertaining to the sample. After determining particle size, the material may be discharged onto a first transport conveyor 40 which moves the dried sample to the mill 43 in the grinding circuit 35. The discharged material from the particle size analyser 56 may alternatively be provided directly to an infeed of the mill 43. As illustrated, a hopper 41 and/or a feed chute 42 may be optionally provided between the particle size analyser 56 and mill 43 to facilitate feeding of the material into the mill 43. As previously mentioned, the mill 43 may not be required for filter cake samples having extremely fine particles.

A screen 44 may be provided downstream of the mill 43 to pass an undersized fraction leaving the mill 43 to a second transport conveyor 45, and an oversized fraction to a regrind conveyor 54. The second transport conveyor 45 may convey the undersized particles to a holder form 46. Alternatively, the undersized fraction may be dumped directly onto the holder form 46 without an intermediate second transport conveyor 45.

An indexing mechanism 47 may move the filled holder form 46 to a press 48 for pressing the material collected by the holder form 46. This pressing station may be configured to create a pressed sample which can be moved to an XRD and/or XRF analyser 50. A shield 49 may be provided around the XRD and/or XRF analyser 50 for reduced interference, improved accuracy, and safety. The indexing mechanism 47 may be configured to pass the pressed sample through the shield. It is envisaged that in some embodiments, a press 48 and/or holder form 46 may not be necessary, and that XRD and/or XRF analysis may take place directly on the indexing mechanism 47 (e.g., material may simply be scattered on a conveyor belt).

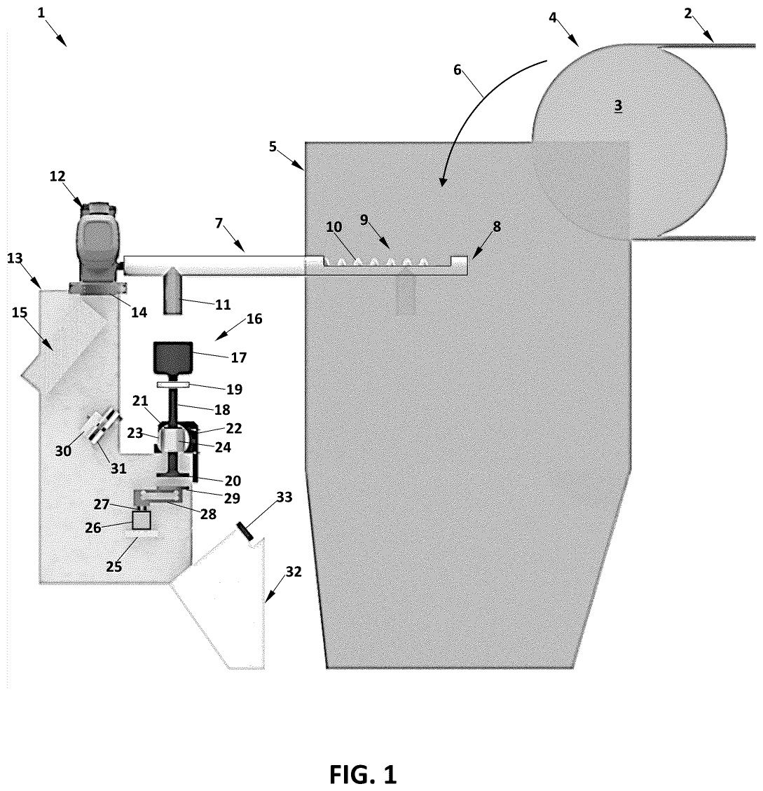

After the optional XRD and/or XRF analysis, the indexing mechanism 47 may move the holder form 46 containing the measured pressed sample to a discharge area 51 where the pressed sample can be discharged from the holder form 46 (e.g., by gravity, vibration, and/or air blow). A sprayer 33 similar to the one depicted in FIGS. 1-14 may be placed within the holder form discharge area 51 to loosen the pressed sample from its holder form 46. The dislodged pressed sample may fall into a hopper or chute 52 and/or onto a third transport conveyor 53 to be re-combined with the cake discharge 6 at the re-combination stage 39. Other means for disposing of the dislodged pressed sample may be practiced.

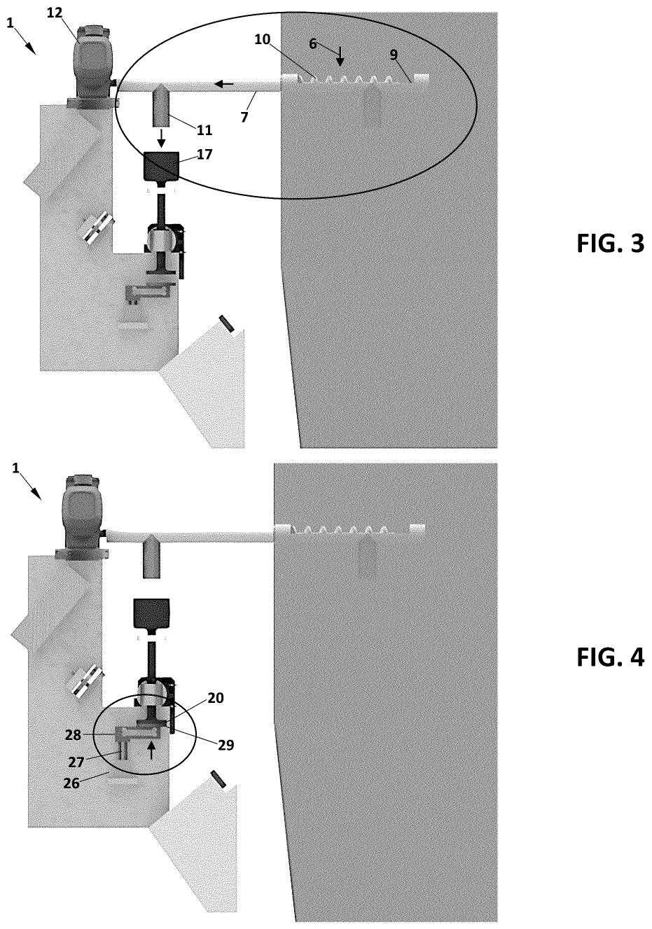

Turning now to FIGS. 1 and 3, while in a standby mode, the drive 12 may rotate transport screw 10 in a reverse-flow direction to move all material within the body of the probe 7 away from the sample collection cup 17 and back into the general material stream of the cake discharge material 6. At the time when a cake discharge 6 specimen is required, or at a preset time interval the transport screw 10 may leave the standby mode and enter a sample collection mode. During the sample collection mode, the drive 12 may change its direction of rotation to draw material collected in catch basin 9 towards the probe discharge 11, out the probe discharge, and then into the sample collection cup 17 of the cup assembly 16 by gravity while the cup assembly 16 is held in a first cup assembly position.

The transport screw 10 may rotate until a required or predetermined mass of collected sample filter cake 6 is collected in the sample cup 17. For example, a sample cup 17 may be deemed to be “filled” when it reaches a pre-specified measurement value of mass (e.g., within +−100 g, without limitation) as indicated by the load cell 28. As indicated in FIG. 4, the load cell 28 may be brought into contact with a distal end 20 of the cup assembly 16 by virtue of the actuator 26. Other conceivable means for weighing the cup assembly in the first cup assembly position are anticipated.

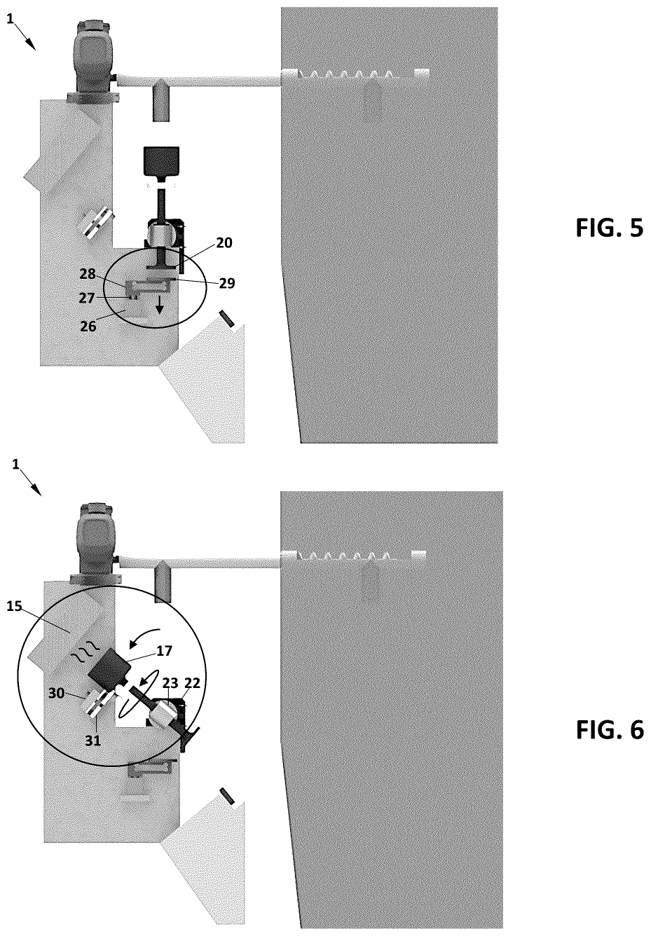

Turning now to FIG. 5, the actuator 26 may reverse its direction to lower the load cell 28 and provide clearance between it and the cup assembly 16. As shown, this may be accomplished by retracting a pneumatically or electronically actuated rod or shaft 27. In doing so, the cup assembly may move down within bearing 24 and the stop limiter 21 may seat into its position for swiveling to a second cup assembly position for drying. It should be understood that stop limiter 21 may be provided by a lower surface portion of sample cup 17 or a lower surface portion of flange 19, without limitation. Any conceivable means (e.g., nub, shoulder, protrusion, flange, projecting fastener) for limiting downward movement of cup assembly through bearing 24 may be employed to cup assembly 16 and serve as stop limiter 21, without limitation.

Turning now to FIG. 6, the rotational actuator 22 may rotate the plate 23 to which the bearing 24 (supporting the cup assembly 16) is mounted. In doing so, the cup assembly 16 may be moved to the second cup assembly position for drying by dryer 15.

Dryer 15 may dry the collected sample within the sample cup 17, e.g., via an IR lamp or equivalent means for drying, without limitation. While drying in the second cup assembly position, a spinner 31 may rotate the cup assembly 16 within the bearing 24. This may be accomplished in a plethora of ways. As depicted, the spinner 31 may employ a moving drive belt 31a. The drive belt 31 may rotate a wheel 31b that frictionally engages an outer surface portion of the cup assembly 16 (e.g., flange 19, shaft 18, or sample cup 17) to induce rotation thereof. In some embodiments, a wheel 31b of the spinner 31 may be provided as an idler wheel, driven wheel, or a guide. In some embodiments, drive belt 31 may frictionally contact an outer surface portion of the cup assembly 16 to induce rotation thereof.

It should be understood that other means for spinning cup assembly 16 may be employed. For instance, while not shown, wheel 31b may comprise teeth (e.g., a rotating sprocket drive gear) that meshes with a complementary set of teeth provided to a periphery of flange 19, without limitation.

During the drying step, in FIG. 6, the sample collection cup 17 (filled with a specimen of collected filter cake 6) may be rotated under IR lamps which are provided to the dryer 15. A component of the spinner 31 may contact a portion of the cup assembly to slowly rotate the cup assembly 16 along its shaft 18 axis. Because of the rotation of the cup at this angle, a majority of the sample cake discharge material 6 within the sample cup 17 may be exposed to the IR lamps for maximum drying efficiency. Due to a high induced angle of repose and angular changes throughout the axial rotation of sample cup 17, it may be ensured that upper exposed surfaces of material stacked in sample cup dry and then break free and slide down to expose fresh particle surfaces beneath for drying.

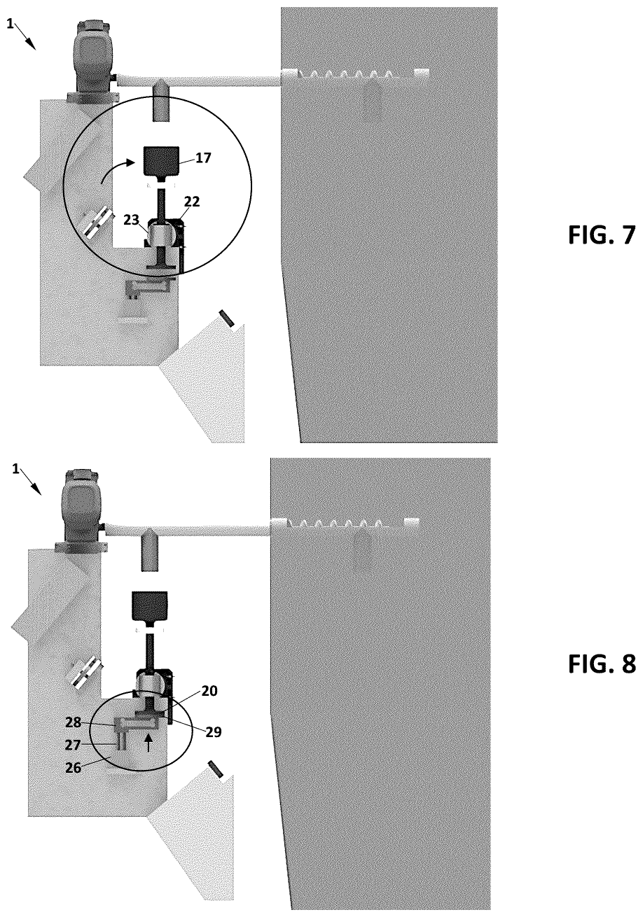

Turning now to FIGS. 7 and 8, after a predetermined duration of drying time which is sufficient to dry the collected filter cake 6 contained within the sample cup 17, the cup assembly 16 may be rotated back to the first cup assembly position via the rotational actuator 22. There, the cup assembly 16, together with its contents of sample cup 17 may be re-weighed “dry”. Moisture (i.e., liquid) lost through evaporation during drying by dryer 15 may be calculated using the initial (wet) mass and the second (dry) mass of the collected sample. For example, the following equation may be used:

$$Filter cake sample \% moisture = \frac{[ \begin{matrix}Cup assembly w / \\ wet sample mass\end{matrix} - \begin{matrix}Cup assembly w / \\ dry sample mass\end{matrix} ]}{\begin{matrix}Cup assembly w / \\ wet sample mass\end{matrix}} \times 100$$

If the mass loss between wet and dry sample weighing cycles results in less than a target predetermined moisture content percentage value (%), then the filter cake sample material 6 is considered “dry” and % moisture is captured and this information can be relayed to the plant distributed control system (DCS) or laboratory information management system (LIMS). The information can be archived in a database and/or used as an input to a loop feedback control system algorithm which determines input control adjustments to the filter producing the sampled cake discharge 6.

If the mass loss between wet and dry sample weighing cycles is unexpectedly higher than anticipated (i.e., the calculated filter cake sample % moisture exceeds the predetermined moisture content percentage value (%), then the cup assembly 16 may be rotated back to the second cup assembly position (FIG. 6), and re-exposed to the dryer 15 for additional drying time to ensure all material within sample cup 17 has undergone sufficient and complete drying. In this regard, the cup assembly 16 can be re-weighed after supplemental drying time to obtain a second replacement “dry” mass value. If the supplemental “dry” mass value still results in a calculated filter cake sample % moisture that exceeds the predetermined percentage value (%), then the DCS may be alarmed and a control input setting adjustment instruction delivered to the filter producing the sampled filter cake 6. In this regard, an operational setting parameter may be adjusted to foster dryer cake formation, without limitation. Collection of samples and subsequent filter adjustments may be performed until the calculated filter cake sample % moisture no longer exceeds the predetermined percentage value (%).

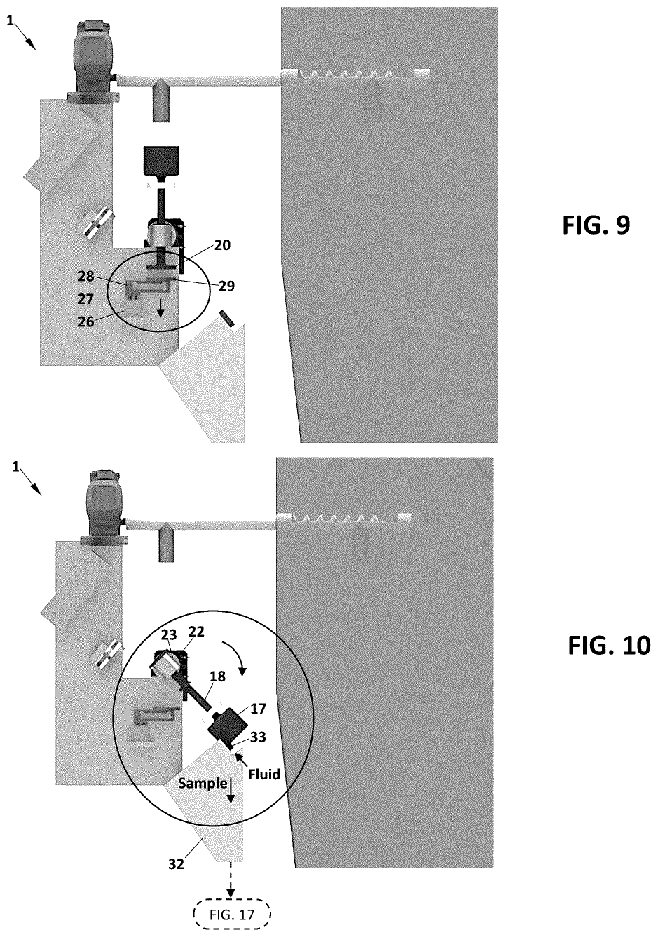

Turning now to FIGS. 9 and 10, once the moisture value (%) has been calculated using the “wet” and “dry” sample masses, the load cell 28 may be disengaged from the cup assembly 16 and the cup assembly 16 rotated to a third cup assembly position (e.g., a sample cup “cleaning” position). In this third cup assembly position, the contents of the sample cup 17 may be discharged from the sample cup 17 and a sprayer 33 comprising a high-pressure fluid jet or spray nozzle may be used to rinse the cup 17 of all remaining collected material contents in preparation for the next measurement cycle. The fluid(s) ejected from the sprayer 33 may comprise one or more inert gases (e.g., air, nitrogen) and/or a liquid (e.g., water, alcohol, or other solvent), without limitation. Sprayer 33 may comprise two nozzles, one for expelling liquids, and another for expelling gasses.

The nozzles may be operated in unison or alternate (E.g., a staged fluid cleaning stage followed by an air blow/dry stage), without limitation.

The waste sample cake discharged from the sample cup 17 may be collected and transferred to a waste collection tank, or it can be transferred back into the general cake discharge stream 6 (e.g., via a chute 32). The destination of the discharged cup material may depend on how much liquid is required by the sprayer 33 to clean the sample cup 17. As shown, the dry waste sample cake discharged from the sample cup 17 in the third cup assembly position may optionally enter secondary analysis processing stages made possible by supplemental analyser 1 apparatus (see FIGS. 16 and 17).

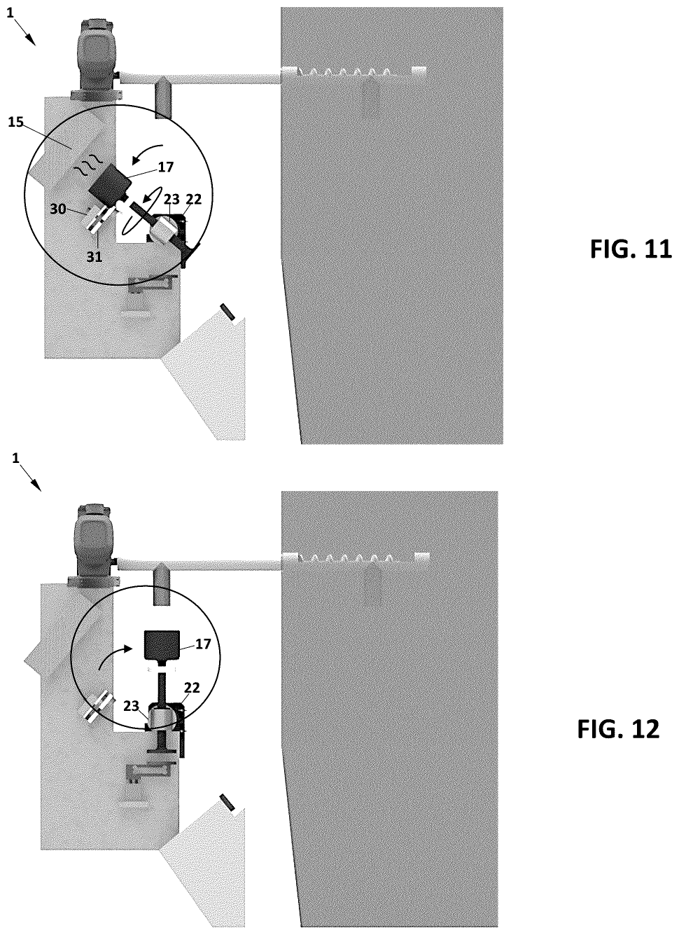

Turning now to FIG. 11, after cleaning the sample cup 17, the cup assembly 16 may be rotated back to the second cup assembly position, via rotational actuator 22, for drying. As depicted in FIG. 12, after drying, the cup assembly 16 may revert back to the first cup assembly (standby) position.

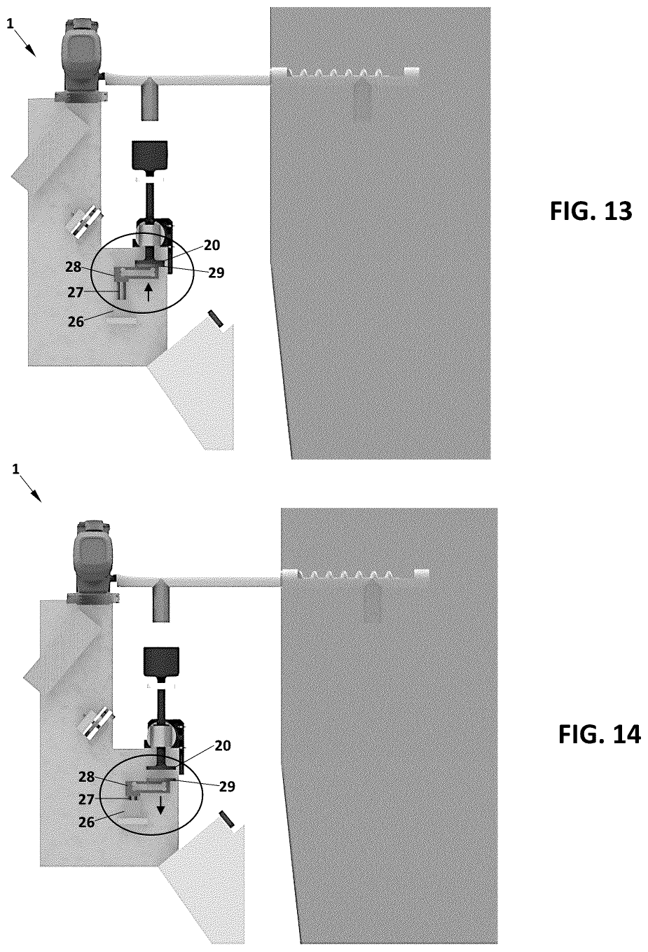

Turning now to FIGS. 13 and 14, once the sample cup 17 has been emptied, washed, and dried, a new mass of the empty cup assembly 16 may be made to zero out the tare weight of the cup assembly 16 and/or perform calibration steps so that a new filter cake sample measurement and analysis cycle can be performed. In this regard, a new sample from filter cake 6 discharge stream can be collected.

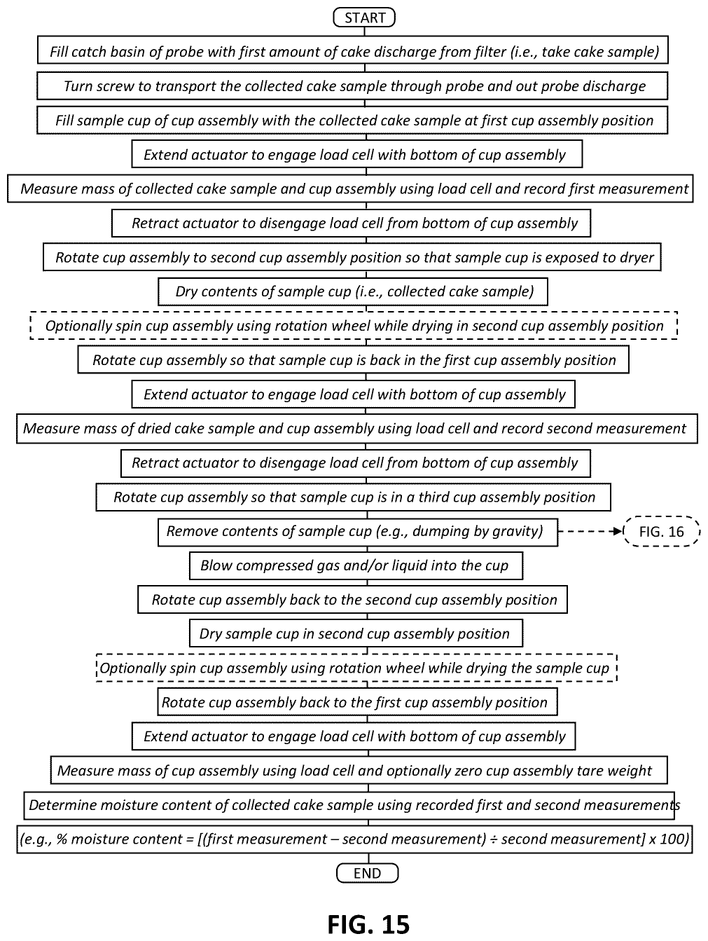

FIG. 15 describes a method of using a filter cake analyzer 1 according to some embodiments of the invention. Discharged sample material leaving sample cup 17 in the eighth method step (FIG. 10) may be transported to a separate holding station, separately discarded, re-combined with cake 6 discharge stream in chute 5, or may optionally move to secondary analysis described in FIG. 16 and shown in 17. Secondary analysis may include measurements regarding filter cake 6 particle size, mineralogy, and/or composition, without limitation.

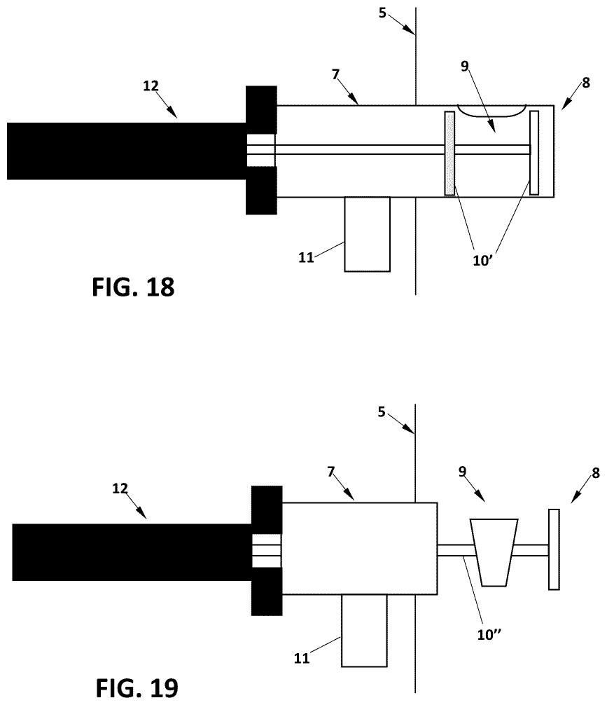

Turning now to FIGS. 18 and 19, a probe 7 may, according to some alternative embodiments, comprise means other than a screw drive or auger for transporting collected cake discharge 6 material from catch basin 9 to probe discharge 11. For example, as depicted in FIG. 18, a fluid-actuated cylinder, solenoid, or linear actuator may be employed as a drive 12, and such a drive 12 may be configured to push, pull, extend, and/or retract a rod equipped with two pistons 10′ collectively defining a catch basin 9 therebetween. Cake discharge 6 leaving a filter may enter through an open portion of the body of the probe 7 (e.g., fall through an upper opening) and be received into the catch basin 9 where it can be subsequently transported to the probe discharge 11 via linear actuation of the drive 12.

As depicted in FIG. 19, a catch basin 9 may be configured as a cup which may be fixed or pivotable on a rod of a linear actuator drive 12. The cup may be filled by cake discharge leaving filter cake conveyor belt 2, and may be transported to probe discharge 11 via linear actuation of the drive 12. Using a cam or ramped surface within the probe 7, a hinged or articulating cup, may rotate with respect to the rod upon engaging the cam or ramped surface and subsequently dump the contents of the cup through probe discharge 11. Alternatively, a non-articulating cup that is fixed to the rod may be rotated or spun about the axis of the rod to dump the contents of the cup through probe discharge 11, without limitation. Other known forms or types of sampling probes 7 may be practiced.

In some embodiments, the probe 7 may comprise a screw-, plunger-, or movable cup-type mechanism. The drive 12 may be actuated using electric current inputs (e.g., for instances where the drive 12 comprises a motor or solenoid) or pneumatic/hydraulic inputs (e.g., for instances where the drive 12 comprises a pressurizable piston or cylinder).

The probe 7 may be permanently positioned in the path of a cake discharge stream 6 (e.g., extend within discharge chute 5 or into path of cake on conveyor 2); or, the probe 7 may be actuated (e.g., intermittently moved or swung into the cake discharge stream 6 or into the path of cake on conveyor 2) prior to cake sampling. For embodiments which employ a transport screw 10, a reversing of the transport screw's 10 rotational direction may be employed for cleaning the probe's 7 internals and removing residual material that may remain in the catch basin 9.

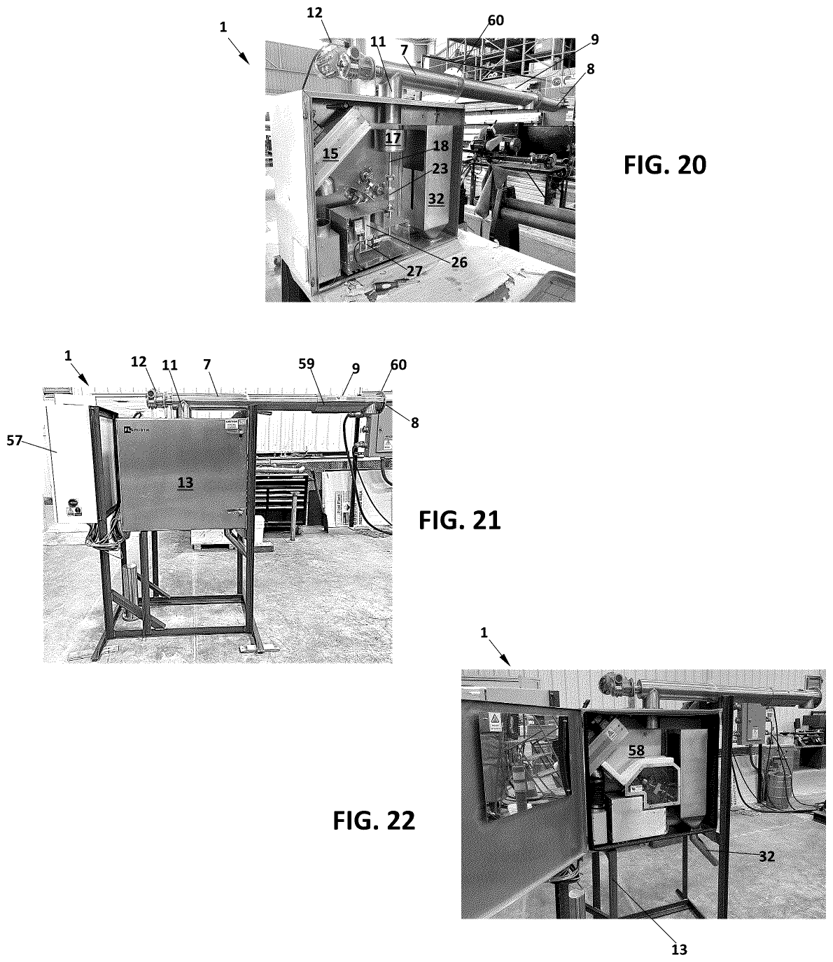

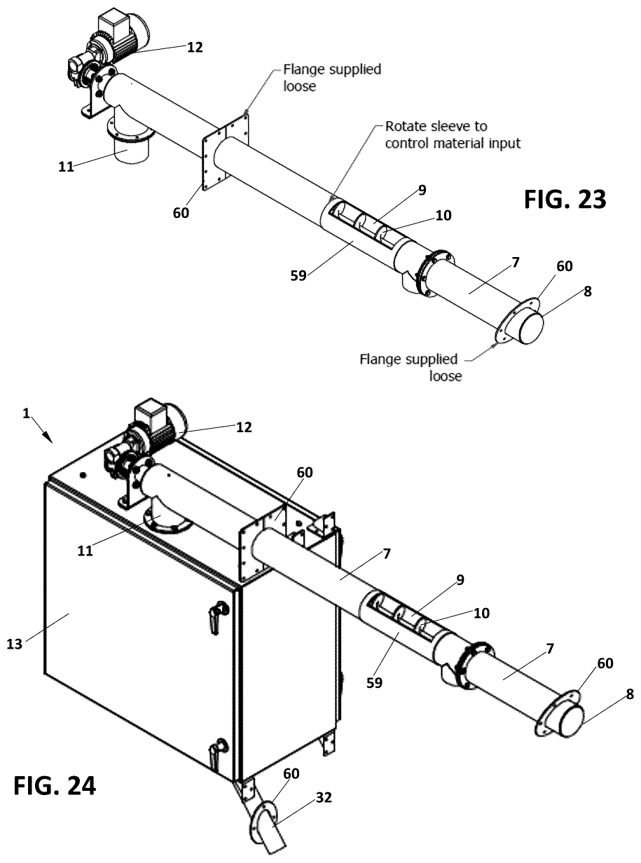

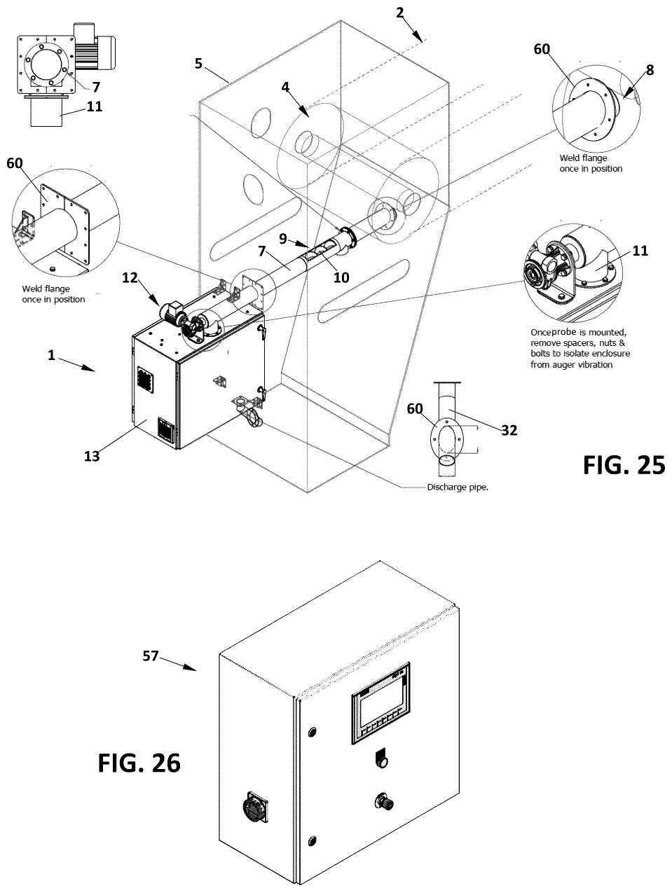

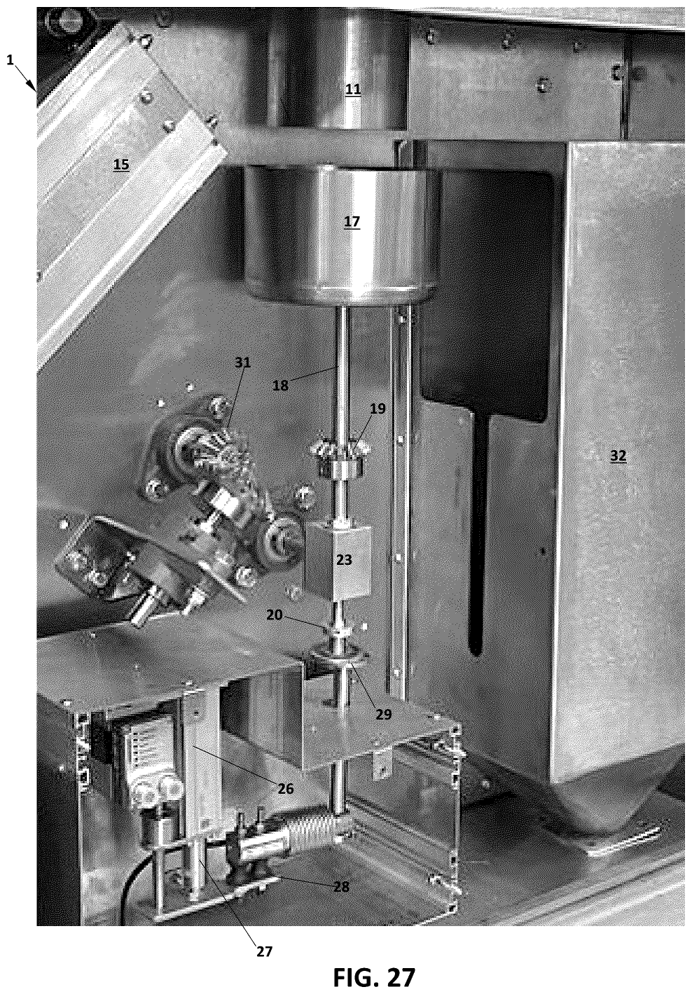

Turning now to FIGS. 20-27, in some embodiments, the chassis 13 may comprise an enclosure supported by a frame. A rotatable or otherwise adjustable sleeve 59 may be provided to the probe 7 adjacent the catch basin 9. The sleeve 59 may be provided with an upper opening and may be configured to be rotated to reduce or increase the size of a feed receiving opening in an upper surface portion of the probe 7, without limitation. In other words, by rotating the sleeve 57, more or less filter cake 6 passing through chute 5 may enter probe 7. Thus, the probe 7 may be configured with a catch basin 9 having an adjustable size, and/or probe 7 may be configured with means for adjusting the size of an inlet orifice or opening or otherwise be configured to adjust the amount of material 6 received in catch basin 9.

As shown, the analyser 1 may operably communicate with a controller 57, such as a programmable logic controller (PLC) unit which may also be conveniently supported by chassis 13. A debris shield 58 may be situated within the analyser 1 (e.g., under probe discharge 11 and/or sample cup 17) to protect load cell 28 and/or other components of the analyser 1, without limitation. Moreover, as depicted, in some embodiments of an analyser 1, one or more adjustable flanges 60 may be provided to portions of the probe 7 (e.g., adjacent distal end 8 and/or proximate probe discharge 11) and/or sample discharge chute/hopper 32. These flanges 60 may be initially provided loosely over components of the analyser 1 for close positioning with respect to surface portions of chute 5. Once flanges 60 are positioned closely to surface portions of the chute 5, they may be subsequently welded or secured by other means (e.g., using adhesive, or using fasteners such as bolts or rivets). Preferably, flanges 60 are seated against or abut surface portions of chute 5 before they are welded/secured to the chute 5 and/or respective components 7, 32 of the analyser 1.

The cake analyser module/assembly 1 and features and uses thereof described and illustrated herein are provided merely as examples to which the invention of the claims may be applied. The specification does not suggest that the claims are somehow limited to or apply only to the particular embodiments shown and described herein.

Those skilled in the art would readily appreciate that the filter cake analyser 1 described herein could be used more generically to measure any type of discharge (including, but not limited to filter cake 4) leaving any type of conveyor belt 2 (including, but not limited to a filter cake conveyor belt 2), and/or passing through any type of discharge chute (including, but not limited to a cake discharge chute 5). Thus, the analyser 1 described herein may find utility in related applications outside of industrial filtration processes and/or flowsheets.

The inventors envisage that instead of measuring filter cake 6, embodiments of the analyser 1 described herein may be used to capture & measure samples of a concentrate (e.g., a copper concentrate, a molybdenum concentrate, a gold concentrate, an iron concentrate, or other concentrate without limitation). Moreover, instead of measuring filter cake 6, embodiments of the analyser 1 described herein may be used to capture & measure samples of a material having fine solid particles like mineral sands, phosphates, and/or the like, without limitation. Especially for concentrates, moisture levels need constant monitoring, and therefore embodiments of the invention may prove to be advantageous in aiding the process of sampling concentrate(s) to ensure proper moisture profiles. In the event material (6) being sampled is too moist, upstream process conditions may be adjusted as necessary to achieve desired moisture.

The above description of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art in light of the above teaching(s).

Accordingly, while some alternative embodiments have been discussed specifically, other embodiments will be apparent or relatively easily developed by those of ordinary skill in the art. The invention is intended to embrace all alternatives, modifications, and variations of the present invention that have been discussed herein, as well as other embodiments that might clearly fall within the spirit and scope of the above-described invention.

In this specification, the terms ‘comprises’, ‘comprising’, ‘includes’, ‘including’, ‘having’, ‘is provided with’—or similar terms are intended to mean a non-exclusive inclusion, such that a described method (or step thereof), or apparatus (or component or assembly thereof) having an inclusion of a list of elements may not necessarily include only those elements (solely), but may also include other elements not listed.

Where used herein, the terms “filter cake (6)” and/or “cake” may be replaced with the terms “solids” or “material” or “concentrate” or “tailings” or “product”, without limitation.

Where used herein, the terms “cake discharge chute (5)” may be replaced with the terms “chute” or “hopper”, without limitation.

Where used herein, the terms “filter cake conveyor belt (2)” may be replaced more generally with “conveyor” or “conveyor belt” or “transport means”, without limitation.

### LIST OF REFERENCE IDENTIFIERS

1 Analyser (e.g., filter cake analyser, solids moisture analyzer)
2 Conveyor belt (e.g., filter cake conveyor belt)
3 End roller
4 Discharge point (e.g., of filter cake or other material)
5 Chute or hopper (e.g., cake discharge chute)
6 Solids material (e.g., filter cake, concentrate, tailings, product)
7 Probe
8 Distal end
9 Catch basin
10 Transport screw/auger (10′ transport plunger, 10″ transport cup rod)
11 Probe discharge
12 Drive (for transport screw 10, plunger 10′, or cup rod 10″)
13 Chassis
14 Drive support mount
15 Dryer (e.g., infrared, heater, microwave, fan)
16 Cup assembly
17 Sample cup
18 Shaft
19 Flange (e.g., stationary, roller idler, driven gear, etc.)
20 Distal end
21 Stop limiter
22 Rotational actuator
23 Rotating plate
24 Bearing (e.g., linear and/or rotational)
25 Actuator support mount
26 Actuator/lift
   (e.g., cylinder, solenoid, linear screw drive, movable linkage)
27 Actuated shaft or rod
28 Load cell (e.g., strain gauge, hydraulic, pneumatic)
29 Abutment surface (e.g., pneumatic platen)
30 Support mount (for cup assembly spinner)
31 Cup assembly spinner (e.g., 31a belt drive, 31b spinner wheel, drive gear)
32 Sample discharge chute/hopper
33 Sprayer (e.g., gas and/or liquid)
34 Optional secondary analyzing circuit
35 Grinding circuit
36 Screening circuit
37 Sample pressing circuit
38 Minerology analysis circuit (e.g., XRF and/or XRD)
39 Recombination stage
40 First transport conveyor
41 Hopper or chute
42 Feed chute
43 Mill
44 Screen
45 Second transport conveyor
46 Holder form
47 Indexing mechanism
48 Press
49 Shield
50 XRD &/or XRF analyzer
51 Holder form discharge area
52 Hopper or chute
53 Third transport conveyor
54 Regrind conveyor
55 Particle size analysis circuit
56 Particle size analyser
57 Controller (e.g., programmable logic controller (PLC) unit)
58 Debris Shield
59 Adjustable sleeve (for adjusting size of catch basin 9 or opening in probe 7)
60 Adjustable flange (e.g., for abutting and welding to cake discharge chute 5)

What is claimed is:

1. A filter cake analyser (1) configured to collect a sample of filter cake (6) produced by a filter comprising:
a probe (7) configured to extend into a path of the filter cake (6); the probe (7) comprising a catch basin (9) for collecting a sample amount of the filter cake (6) therein, a probe discharge (11); and means (10, 10′, 10″) for transporting collected filter cake (6) from the catch basin (9) to the probe discharge (11);
a cup assembly (16) being indexable between three cup assembly positions and having a sample cup (17) provided to an upper proximal portion of the cup assembly (16), a shaft (18), and means (21) provided to the cup assembly (16) for limiting downward travel of the cup assembly (16) within a bearing (24);
a rotational actuator (22) supporting the cup assembly (16) via the bearing (24) and being configured to index the cup assembly (16) into said three cup assembly positions;
a dryer (15) for drying contents of the sample cup (17); and,
a load cell (28) configured to engage the cup assembly (16) and disengage the cup assembly (16) via an actuator (26);
wherein in a first cup assembly position of said three cup assembly positions, the sample cup (17) is arranged above the load cell (28) and beneath the probe discharge (11) to catch collected filter cake (6) passing therethrough;
wherein in a second cup assembly position of said three cup assembly positions, the sample cup (17) is arranged adjacent the dryer (15);
wherein in a third cup assembly position of said three cup assembly positions, contents of the sample cup (17) are removed therefrom.

2. The filter cake analyser (1) according to claim 1, wherein the dryer (15) comprises an infrared (IR) lamp.

3. The filter cake analyser (1) according to any one of the preceding claims, further comprising a sprayer (33) for cleaning out inside surfaces of the sample cup (17) in the third cup assembly position.

4. The filter cake analyser (1) according to any one of the preceding claims, further comprising a spinner (31) for rotating the cup assembly (16) within the bearing (24) in the second cup assembly position.

5. The filter cake analyser (1) according to any one of the preceding claims, wherein the means (10, 10′, 10″) for transporting collected filter cake (6) from the catch basin (9) to the probe discharge (11) comprises a transport screw, plunger, or cup.

6. The filter cake analyser (1) according to any one of the preceding claims, wherein the means (10, 10′, 10″) for transporting collected filter cake (6) from the catch basin (9) to the probe discharge (11) comprises a drive (12) in the form of a motor or a cylinder.

7. The filter cake analyser (1) according to any one of the preceding claims, further comprising means (56) for measuring particle size of particulates within the collected filter cake (6).

8. The filter cake analyser (1) according to any one of the preceding claims, further comprising means (50) for determining the mineralogy and/or composition of particulates within the collected filter cake (6).

9. The filter cake analyser (1) according to any one of the preceding claims, wherein the probe (7) is configured to extend into a cake discharge chute (5), or extend over a filter cake conveyor belt (2) for collecting a sample amount of the filter cake (6).

10. A filter comprising the filter cake analyser (1) according to any one of the preceding claims.

11. A method of analyzing a sample of collected filter cake (6) discharged from a filter using the filter cake analyser (1) according to any one of claims 1-9, the method comprising the steps of:
collecting filter cake (6) in the catch basin (9);
transporting a portion of the collected filter cake (6) from the catch basin (9) to the probe discharge (11);
filling the sample cup (17) with a portion of the collected filter cake (6) via the probe discharge;
weighing the cup assembly (16) to obtain a wet mass;
drying the contents of the sample cup (17) with the dryer (15);
weighing the cup assembly (16) to obtain a dry mass;
determining moisture content of the collected filter cake (6) using the wet mass and dry mass; and
discharging the contents of the sample cup (17).

12. The method of claim 11, further comprising the step of:
cleaning the sample cup (17) using the sprayer (33) defined in claim 3.

13. The method according to claim 12, further comprising the step of:
drying the sample cup (17) after the step of cleaning the sample cup (17).

14. The method according to claim 13, further comprising the step of:
weighing the cup assembly (16) with the sample cup (17) dry and empty; and
zeroing the load cell (28) mass to negate the tare weight of the cup assembly (16) and ready the filter cake analyser (1).

15. An analyser (1) configured to collect and/or measure a sample of solids (6) leaving a conveyor belt (2) and/or passing through a chute or hopper (5); the analyser (1) comprising:
a probe (7) configured to extend into a path of the solids (6); the probe (7) comprising a catch basin (9) for collecting a sample amount of the solids (6) therein, a probe discharge (11); and means (10, 10′, 10″) for transporting collected solids (6) from the catch basin (9) to the probe discharge (11);
a cup assembly (16) being indexable between three cup assembly positions and having a sample cup (17) provided to an upper proximal portion of the cup assembly (16), a shaft (18), and means (21) provided to the cup assembly (16) for limiting downward travel of the cup assembly (16) within a bearing (24);
a rotational actuator (22) supporting the cup assembly (16) via the bearing (24) and being configured to index the cup assembly (16) into said three cup assembly positions;
a dryer (15) for drying contents of the sample cup (17); and,
a load cell (28) configured to engage the cup assembly (16) and disengage the cup assembly (16) via an actuator (26);
wherein in a first cup assembly position of said three cup assembly positions, the sample cup (17) is arranged above the load cell (28) and beneath the probe discharge (11) to catch collected solids (6) passing therethrough;
wherein in a second cup assembly position of said three cup assembly positions, the sample cup (17) is arranged adjacent the dryer (15);
wherein in a third cup assembly position of said three cup assembly positions, contents of the sample cup (17) are removed therefrom.

16. The analyser (1) according to claim 15, wherein the solids (6) comprise filter cake (6) produced by a filter, a dewatered concentrate, mineral sands, phosphate, and/or a material having a higher % solids concentration than liquids in the material.

17. The analyser (1) according to claim 15, wherein the analyser (1) is positioned with its probe (7) within a discharge chute (5) or extending above and perpendicular to a conveyor belt (2) such that it is configured to capture solids (6) being conveyed by the conveyor belt (2) and/or discharge chute (5).
